(19) United States
(12) Patent Application Publication
(10) Pub. No.: US 2008/0285262 A1
(43) Pub. Date: Nov. 20, 2008

(54) LONG LIFE CRANKING MINIMIZED FLASHLIGHT

(75) Inventors: Serafino CANINO, Torrington, CT (US); Scott GELORMINO, Torrington, CT (US)

Correspondence Address: THOMPSON HINE L.L.P.;Intellectual Property Group, P.O. BOX 8801, DAYTON, OH, 45401-8801, US

(73) Assignee: ICC INNOVATIVE CONCEPTS CORPORATION, Canton, CT (US)

(21) Appl. No.: 12/169,623

(22) Filed: Jul. 8, 2008

(51) Int. Cl. F21L 4/08

(52) U.S. Cl. 362/183

(57) ABSTRACT

An improved flashlight having a flashlight housing, comprising an elongated substantially flat gear train having a mechanical input and a mechanical output is disclosed. An elongated substantially flat solar cell supplies power to the system. A control circuit is coupled to said solar cell. A generator is electrically coupled to the control circuit and mechanically coupled to the mechanical output of the elongated substantially flat gear train. An electrical switch is coupled to the control circuit. A rechargeable battery and is positioned within a battery housing, which opens to the outside of the housing of the flashlight coupled to said control circuit. A removable cap closes the battery housing. A crank is mechanically coupled to the input of the gear train.

### TECHNICAL FIELD

The invention relates to flashlights of the type which are recharged by generators.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

In recent years, flashlights incorporating rechargeable batteries and a generator system have seen increasing popularity, particularly in view of the introduction of in-line gearing mechanisms which, because of their elongated shape, combined with their use of a relatively flat battery allow the shaping of a flashlight which may, at once, be easily gripped and cranked to recharge the battery, while at the same time fitting easily in the palm of the hand.

### SUMMARY OF THE INVENTION

In accordance with the invention, an improved cranked flashlight is provided which allows substantial extension of a life of the device, while at the same time minimizing the amount of cranking required.

In accordance with the invention, an improved flashlight having a flashlight housing, comprises an elongated substantially flat gear train having a mechanical input and a mechanical output. An elongated substantially flat solar cell supplies power to the system. A control circuit is coupled to the solar cell. A generator is electrically coupled to the control circuit and mechanically coupled to the mechanical output of the elongated substantially flat gear train. An electrical switch is coupled to the control circuit. A rechargeable battery is positioned within a battery housing, which opens to the outside of the housing of the flashlight coupled to the control circuit. A removable cap closes the battery housing. A crank is mechanically coupled to the input of the gear train.

The rechargeable battery may be replaceable.

The crank may be rotatably mounted near the center of the length of the flashlight housing.

The solar cell may be disposed on one side of the flashlight, and the crank and the battery housing may be disposed on the other side of the housing.

### BRIEF DESCRIPTION THE DRAWINGS

The operation of the invention will become apparent from the following description taken in conjunction with the drawings, in which:

FIG. 1 is a top plan view of the flashlight of the present invention;

FIG. 2 is a schematic diagram illustrating the flashlight of the present invention;

FIG. 3 is a bottom plan view of the present invention;

FIG. 4 is a schematic diagram of an exemplary gear train useful in the present invention;

FIG. 5 is a side view of the inventive flashlight; and

FIG. 6 is a view similar to that of FIG. 5 in which the inventive flashlight is being opened for cranking.

### DETAILED DESCRIPTION OF THE PREFERRED EMBODIMENTS

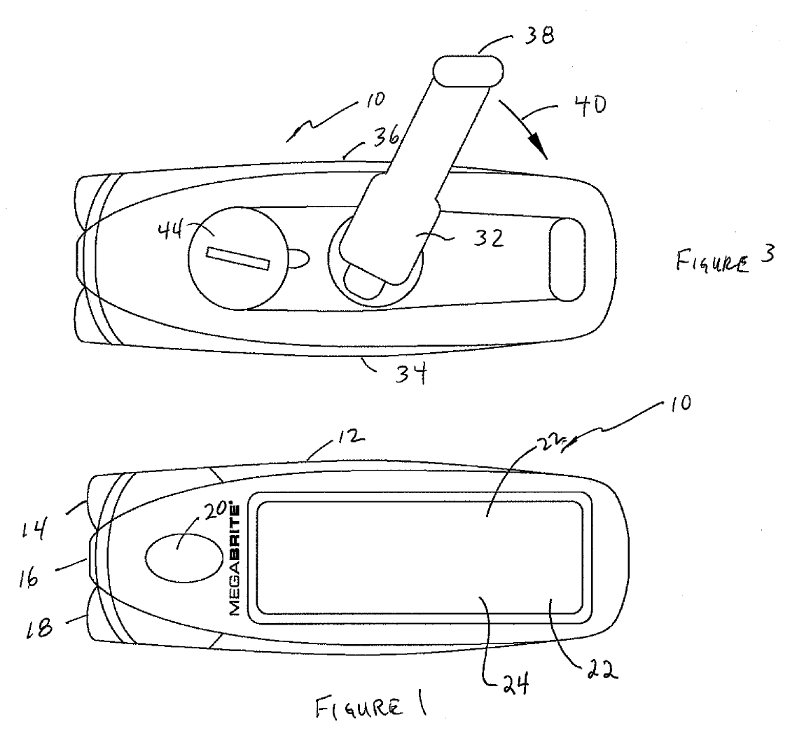

Referring to FIG. 1, the inventive flashlight 10 comprises a housing 12 which houses the components of the inventive flashlight 10. Housing 12 supports three lenses 14, 16 and 18. Positioned behind each of the lenses 14, 16 and 18, is a respective light emitting diode (not illustrated) and, optionally, a respective reflector (not illustrated) for concentrating the output of its respective light emitting diode. Structures of this type are illustrated in U.S. Pat. No. 6,959,999 directed to a flashlight having a manual charging device, the disclosure of which is hereby incorporated into this specification by reference.

Inventive flashlight 10 also comprises a pushbutton actuator 20. Pushbutton actuator 20 may be a simple single pole-single throw on-off electrical switch.

Flashlight 10 also incorporates a solar battery 22 which may be covered with a transparent face 24 to protect the solar battery 22 from the elements. As may be seen from FIG. 1, solar battery 22 takes up most of the top of flashlight 10, barely leaving room for lights 14-18 and switch 20. This maximizes the area for solar electricity generation.

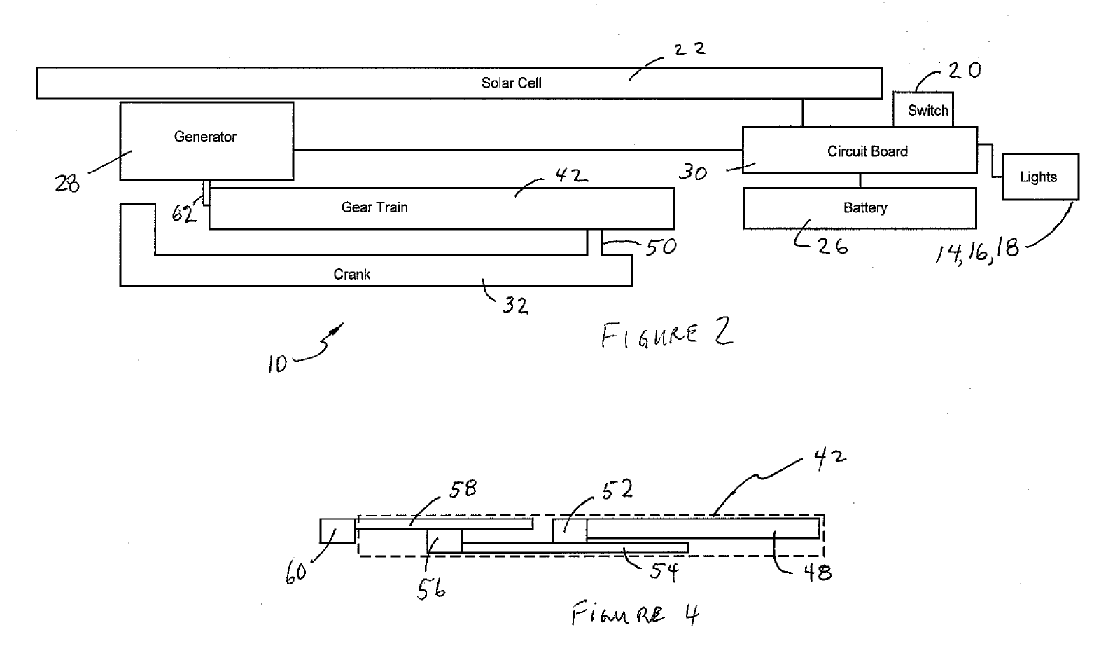

Referring to FIG. 2, the layout and general proportions of the parts of the inventive flashlight are illustrated schematically in FIG. 2. This layout has the advantage of allowing one side to be substantially covered only by the solar cell. At the same time, it allows crank 32 to be placed substantially in the center of the bottom of the flashlight 10, allowing placement of a cap 44 of a battery receiving compartment, thus allowing easy replacement of the battery when it wears out and no longer takes a sufficient charge in the estimation if the user.

In accordance with the preferred embodiment of the invention, it is contemplated that battery 26 is rechargeable. Presently, such batteries are not replaceable and, accordingly, when they are worn out, the flashlight is often discarded. This results in a great waste of economic value and unnecessary environmental damage.

Flashlight 10 comprises a solar battery 26, which supplies power to lights 14-18 in response to actuation of switch 20. Both generator 28 and solar cell 22 are used to recharge battery 26.

Charging of battery 26 by generator 28 and solar cell 22 is done through circuit board 30. Likewise, actuation of lights 14-18 is controlled by switch 22 acting through circuit board 30.

Charging is achieved by the cranking of a crank 32, as illustrated in FIG. 3. Crank 32 is cranked by a user grasping sides 34 and 36 of flashlight 10 with the thumb and index finger of the left hand, respectively. The right thumb and index finger are then used to hold rotatably mounted knob 38 and allow cranking motion in the direction indicated by arrow 40. This results in applying a rotary mechanical input to gear train 42 (FIG. 2).

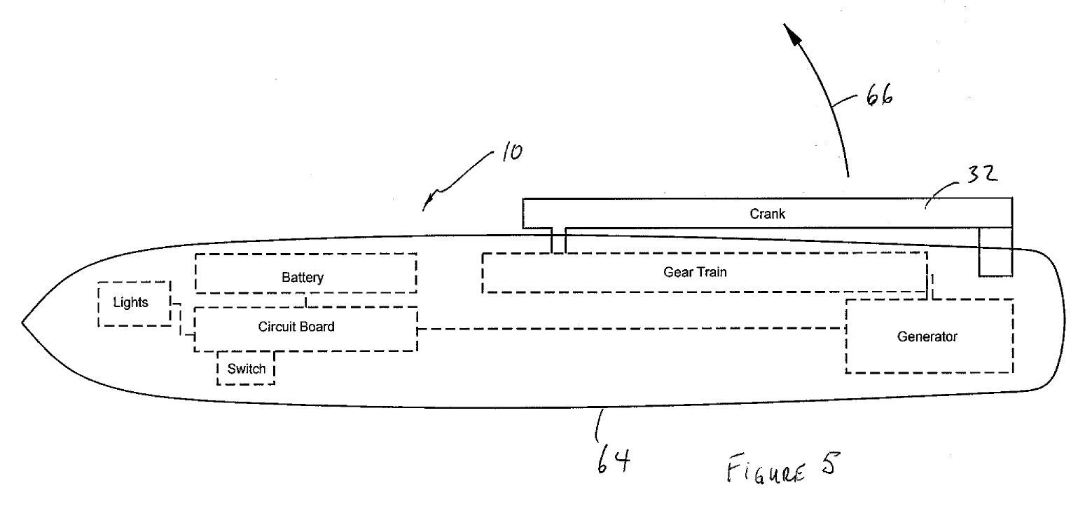

Gear train 42 comprises a number of gears, as illustrated in FIG. 4. A first large gear 48 is driven by the shaft 50 (FIG. 2) of crank 32. Large gear 42, in turn, drives small gear 52. Small gear 52 is mounted on the same shaft, to which it is secured, as large gear 54 which turns as small gear 52 turns. Large gear 54 thus drives small gear 56. Small gear 56 is, in turn, commonly mounted to a single pin, to which it is secured, with a large gear 58. Consequently, large gear 58 drives gear 60, which is mounted on the shaft 62 of generator 28, to which it is secured. This results in the generation of electricity for recharging the battery when the crank is turned. This generation of electricity supplements the generation of electricity by the solar cell in the charging of the battery.

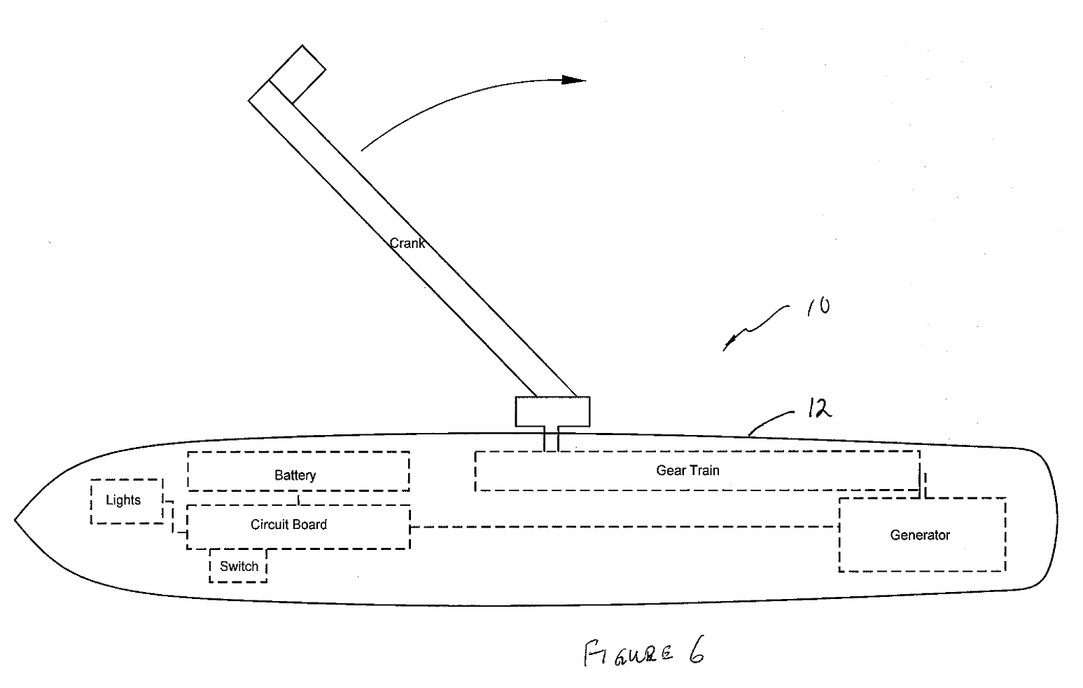

The placement of the operative parts of the flashlight within housing 12 is illustrated in FIG. 5. As can be seen from FIG. 5 the parts are ergonomically laid out into an elongated train, while providing a wide and long open area 60 for the placement of solar cell 22 in the positioned illustrated FIG. 2.

When it is desired to charge the inventive flashlight, crank 32 is rotated outwardly in the direction of arrow 66, until it takes the position illustrated in FIG. 6, and then rotation is continued until it is substantially parallel to the housing 12 of flashlight 10. This position is illustrated in FIG. 3 and in this position, crank 32 is rotated in the direction of arrow 40.

As an alternative, cranking it is not necessary, as the flashlight may be left in, for example, sunlight and solar battery 22 will recharge rechargeable battery 26. Even if it is not fully charged, it will operate long enough to be of use in many cases, and if additional charging is required, the total amount of cranking required for any amount of use is reduced by the supplement of sunlight.

While an illustrative embodiment of the invention has been described, it is understood that various modifications will be obvious to those of ordinary skill in the art. Such modifications are within the spirit and scope of the invention which is limited and defined only by the accompanying claims.

What is claimed:

1. A flashlight having a flashlight housing, comprising:
(a) an elongated substantially flat gear train having a mechanical input and a mechanical output;
(b) an elongated substantially flat solar cell;
(c) a control circuit coupled to said solar cell;
(d) a generator electrically coupled to said control circuit and mechanically coupled to the mechanical output of said elongated substantially flat gear train;
(e) an electrical switch coupled to said control circuit;
(f) a rechargeable battery positioned within a battery housing opening to the outside of the housing of said flashlight, said rechargeable battery being coupled to said control circuit;
(g) a removable cap closing said battery housing; and
(h) a crank mechanically coupled to the input of said gear train.

2. Apparatus as in claim 1, wherein the rechargeable battery is replaceable.

3. Apparatus as in claim 1, wherein said crank is rotatably mounted near the center of the length of said flashlight housing.

4. Apparatus as in claim 1, wherein said solar cell is disposed on one side of said flashlight, and said crank and said battery housing are disposed on the other side of said housing.
